(19) United States
(12) Patent Application Publication
(10) Pub. No.: US 2010/0271705 A1
(43) Pub. Date: Oct. 28, 2010

(54) LIGHT BLOCKING PLATE ARRAY, AND LENS MODULE ARRAY WITH SAME

(75) Inventor: HSIN-CHIN HUNG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/606,267

(22) Filed: Oct. 27, 2009

(30) Foreign Application Priority Data
Apr. 24, 2009 (CN) 200910301809.7

(51) Int. Cl. G02B 27/00; G02B 5/20

(52) U.S. Cl. 359/601; 359/738

(57) ABSTRACT

An exemplary light blocking plate array includes a light transmissive plate, and a light blocking layer formed on the light transmissive plate. The light transmissive plate includes many light transmissive areas spaced apart from each other, and a peripheral area surrounding the light transmissive areas. Each of the transmissive areas is a solid structure. The light blocking layer is formed on the peripheral area.

### BACKGROUND

1. Technical Field

The present disclosure relates to imaging technology; and particularly to a light blocking plate array, and a lens module array with the light blocking plate array.

2. Description of Related Art

With the ongoing development of optical imaging technology, lens modules are widely used in electronic devices such as digital cameras, mobile phones, etc.

Generally, a camera of an electronic device includes a lens module and an image sensor. The lens module includes optical members such as lenses, filters, etc. In the process of assembling a lens module, first, a first wafer including many first optical members arranged in an array, a second wafer including many second optical members arranged in an array, and a third wafer including many image sensors arranged in an array are provided. Next, the first wafer is coupled to the second wafer, and then coupled to the third wafer to form a lens module array. Finally, the lens module array is cut into many individual lens modules.

When one of such lens modules is employed in a camera module, some light entering the camera module is liable to be reflected by the optical members before reaching the image sensor. When this happens, flares may occur in the images captured by the image sensor. That is, the performance of the lens module is liable to be unsatisfactory.

Therefore, what is needed is a light blocking plate array and a lens module array with the light blocking plate array, which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flowchart of a method for making a light blocking plate array according to a first embodiment.

FIGS. 2-6 illustrate successive stages in making the light blocking plate array according to the method of FIG. 1.

FIG. 7 is a schematic, cross-sectional view of the light blocking plate array of FIG. 1 with a plurality of filter layers formed therein.

FIG. 8 is similar to FIG. 7, but showing the light blocking plate array after alignment through holes have been formed in it.

FIG. 9 is a schematic, cross-sectional view of a light blocking plate array according to a second embodiment.

FIG. 10 is a schematic, cross-sectional view of a lens module array according to a third embodiment.

### DETAILED DESCRIPTION

Embodiments will now be described in detail below with reference to the drawings.

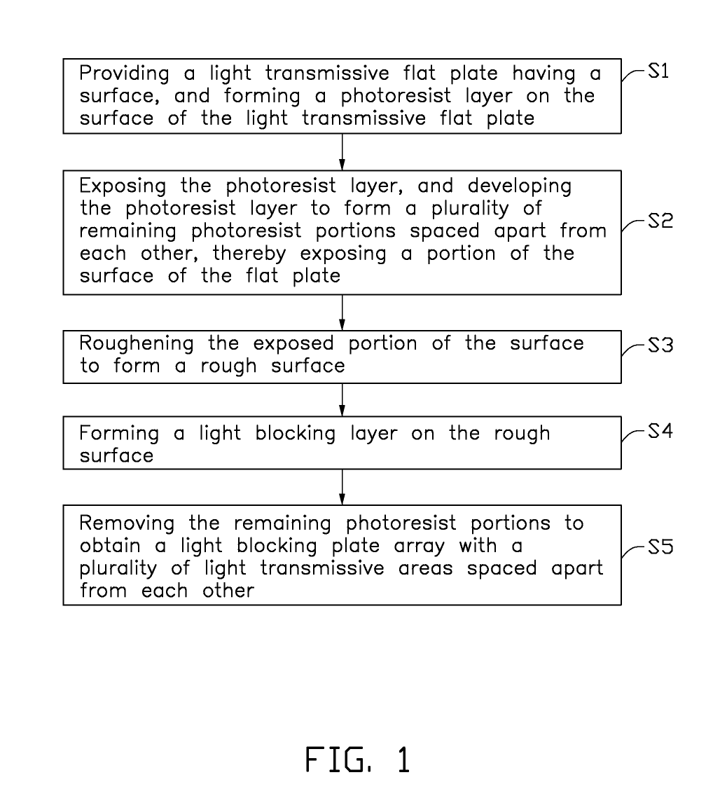

Referring to FIG. 1, a method for making a light blocking plate array, in accordance with a first embodiment, includes the following steps: S1, providing a light transmissive flat plate having a surface, and forming a photoresist layer on the surface of the light transmissive flat plate; S2, exposing the photoresist layer, and developing the photoresist layer to form a plurality of remaining photoresist portions spaced apart from each other, thereby exposing a portion of the surface of the flat plate; S3, roughening the exposed portion of the surface to form a rough surface; S4, forming a light blocking layer on the rough surface; and S5, removing the remaining photoresist portions to obtain a light blocking plate array with a plurality of light transmissive areas spaced apart from each other.

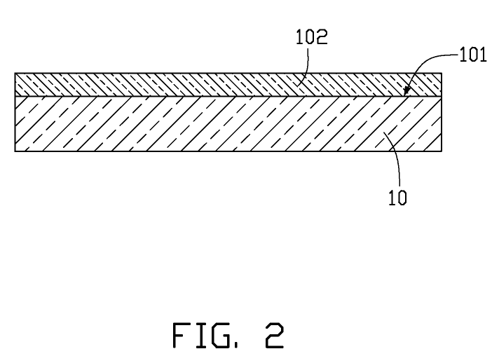

In step S1, referring to FIG. 2, a light transmissive flat plate 10 having a surface 101 is provided. A photoresist layer 102 is formed on the surface 101 of the light transmissive flat plate 10. In the present embodiment, the light transmissive flat plate 10 is made of glass. The photoresist layer 102 is formed on the surface 101 by spin coating. In other embodiments, the light transmissive flat plate may instead be made of plastic, and the photoresist layer 102 may instead be formed on the surface 101 by spray coating.

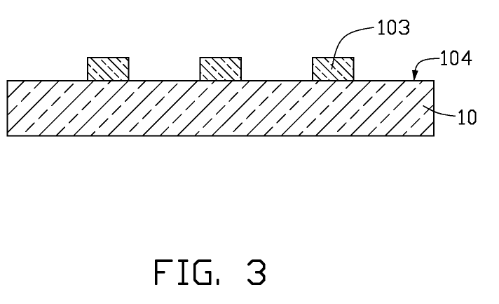

In step S2, referring to FIG. 3, the photoresist layer 102 is exposed by light passing through a photomask (not shown), and developed by a developer (not shown) to form a plurality of remaining photoresist portions 103 spaced apart from each other. In this way, a portion 104 of the surface 101 is exposed. In the present embodiment, the remaining photoresist portions 103 are cylindrical (or annular), and are arranged in an array (e.g. an m×n matrix). In other embodiments, the remaining photoresist portions 103 may instead be shaped as cubes, square prisms, triangular prisms, etc.

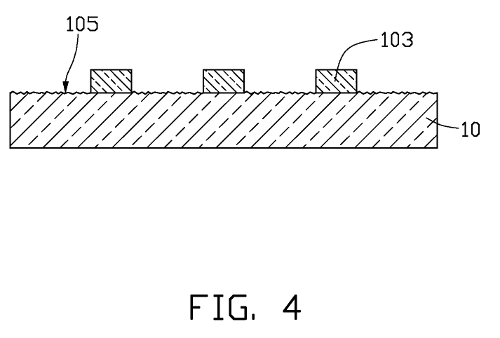

In step S3, referring to FIG. 4, the portion 104 of the surface 101 is roughened to form a rough surface 105. In the present embodiment, the portion 104 of the surface 101 is roughened by dry etching. In other embodiments, the portion 104 of the surface 101 may instead be roughened by wet etching, grinding, etc.

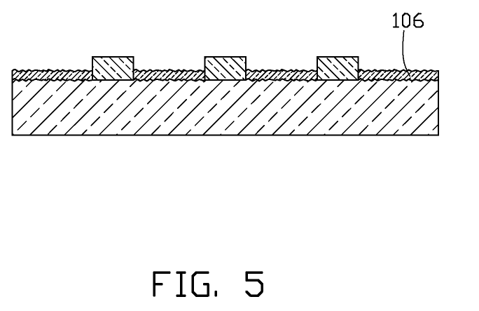

In step S4, referring to FIG. 5, a light blocking layer 106 is formed on the rough surface 105. In the present embodiment, the light blocking layer 106 is formed on the rough surface 105 by sputtering. The light blocking layer 106 is made of chromium (Cr). In other embodiments, the light blocking layer 106 may instead be made of titanium nitride (TiN).

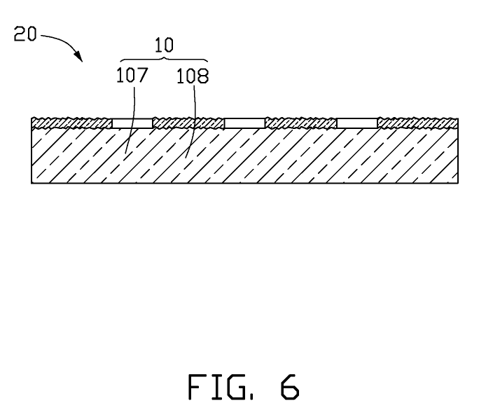

In step S5, referring to FIG. 6, the remaining photoresist portions 103 are removed from the light transmissive flat plate 10 to obtain a light blocking plate array 20. The light blocking plate array 20 includes a plurality of light transmissive areas 107 spaced apart from each other, and a peripheral area 108 surrounding the light transmissive areas 107. Each of the light transmissive areas 107 is a solid structure, and includes two surfaces parallel with each other. The light transmissive areas 107 are located below a plurality of holes left in the light blocking layer 106, respectively. The peripheral area 108 includes the rough surface 105.

The light blocking plate array 20 can then be employed in a lens module array (see the below description regarding a lens module array 30). The lens module array can be cut into a plurality of individual lens modules, each lens module corresponding to one light transmissive area 107 and a surrounding portion of the peripheral area 108. Each such lens module can then be employed in, e.g., a camera.

When a lens module derived from the light blocking plate array 20 is employed in a camera, the corresponding light blocking layer 106 can absorb light reflected by other optical members (not shown) of the camera, such as lenses, filters, etc. In addition, even when some of the light reflected by the other optical members is not absorbed by the light blocking layer 106, diffuse reflection of such light occurs at the rough surface 105. Thus, the light reflected by the other optical members can be effectively prevented from entering an image sensor (not shown) of the camera, or the amount and/or concentration of such light entering the image sensor can at least be minimized. Thereby, flares occurring in images captured by the image sensor can effectively be eliminated or at least minimized.

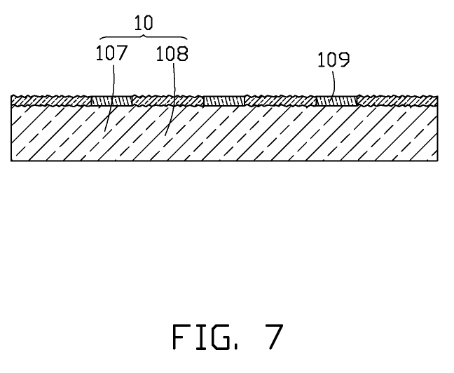

Referring to FIG. 7, a plurality of filter layers 109 can be formed on the respective light transmissive areas 107 in the holes of the light blocking layer 106. In the present embodiment, each of the filter layers 109 is an infrared cut-off filter coating. In other embodiments, each filter layer 109 may instead be a low pass filter coating, an ultraviolet cut-off filter coating, etc.

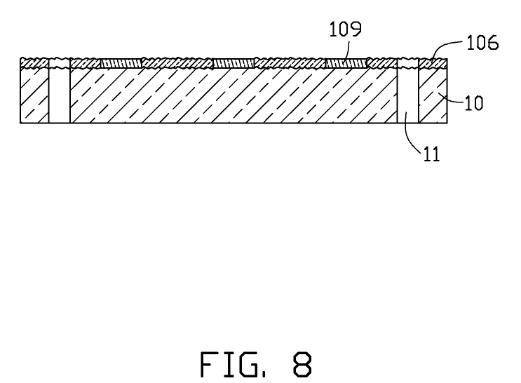

Referring to FIG. 8, the peripheral area 108 can have at least two alignment through holes 11 defined therein. The alignment through holes 11 are configured for aligning the light blocking plate array 20 with a lens array (not shown), thereby ensuring that the light transmissive areas 107 are coaxial with lenses (not shown) of the lens array, respectively. In the present embodiment, each of the alignment through holes 11 is cylindrical. In other embodiments, the alignment through holes 11 may instead be shaped as cubes, square prisms, triangular prisms, etc.

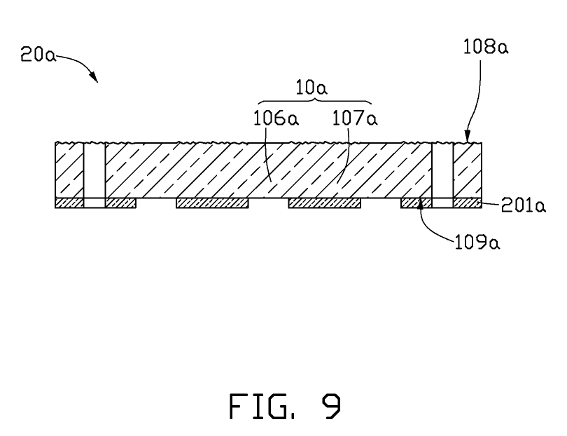

Referring to FIG. 9, a light blocking plate array 20a, in accordance with a second embodiment, is shown. The light blocking plate array 20a includes a light transmissive flat plate 10a. The light transmissive flat plate 10a includes a plurality of light transmissive areas 106a spaced apart from each other, and a peripheral area 107a surrounding the light transmissive areas 106a. Each of the light transmissive areas 106a is a solid structure. The peripheral area 107a includes a first surface 108a and a second surface 109a at opposite sides of the light transmissive flat plate 10a. The first surface 108a is a rough surface. The light blocking plate array 20a also includes a light blocking layer 201a formed on the second surface 109a. In the present embodiment, the second surface 109a is a smooth surface. In other embodiments, the second surface 109a may instead be a rough surface.

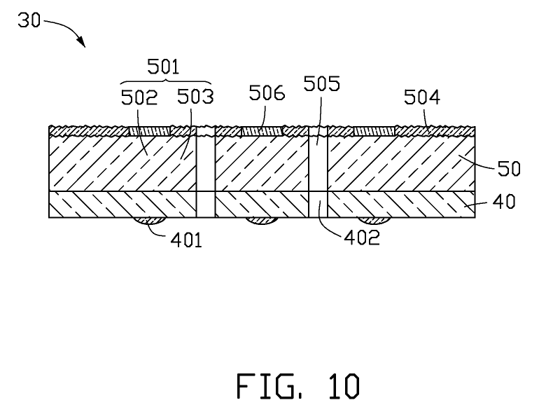

Referring to FIG. 10, a lens module array 30, in accordance with a third embodiment, is shown. The lens module array 30 includes a lens array 40, and a light blocking plate array 50 attached on the lens array 40.

The lens array 40 includes a plurality of lenses 401 spaced apart from each other, and at least two alignment structures 402 among or surrounding the plurality of lenses 401. In the illustrated embodiment, the alignment structures 102 comprise through holes, and at least one alignment structure 402 is disposed between two of the lenses 401. In other embodiments, the alignment structures 102 may instead be protrusions, recesses, etc.

The light blocking plate array 50 includes a light transmissive flat plate 501. The light transmissive flat plate 501 includes a plurality of light transmissive areas 502 spaced apart from each other, and a peripheral area 503 surrounding the light transmissive areas 502. Each of the light transmissive areas 502 is a solid structure. The light blocking plate array 50 also includes a light blocking layer 504 formed on the peripheral area 503, at least two alignment through holes 505 defined in the peripheral area 503, and a plurality of filter layers 506 formed on the respective light transmissive areas 502 of the light transmissive flat plate 501. The alignment through holes 505 are aligned with the respective alignment structures 402, thereby ensuring that the light transmissive areas 502 are coaxial with the respective lenses 401. That is, the light blocking plate array 50 and lens array 40 are properly aligned with each other.

A lens module (not shown) derived from the lens module array 30 can be employed in, e.g., a camera (not shown). In this application, the light blocking layer 504 can absorb light reflected by the corresponding lens 401 or by other optical members (e.g. a filter) of the camera. In addition, even when some of the light reflected by the lens 401 or the other optical members is not absorbed by the light blocking layer 504, diffuse reflection of such light occurs at the rough surface of the peripheral area 503. Thus, the light reflected by the lens 401 or the other optical members can be effectively prevented from entering an image sensor (not shown) of the camera, or the amount and/or concentration of such light entering the image sensor can at least be minimized. Thereby, flares occurring in images captured by the image sensor can effectively be eliminated or at least minimized.

While certain embodiments have been described and exemplified above, various other embodiments will be apparent to those skilled in the art from the foregoing disclosure. The disclosure is not limited to the particular embodiments described and exemplified but is capable of considerable variation and modification without departure from the scope and spirit of the appended claims.

What is claimed is:

1. A light blocking plate array comprising:
a light transmissive plate, the light transmissive plate comprising a plurality of light transmissive areas spaced apart from each other, and a peripheral area surrounding the light transmissive areas, each of the light transmissive areas being a solid structure; and
a light blocking layer formed on the peripheral area.

2. The light blocking plate array of claim 1, wherein the peripheral area comprises a first surface of the light transmissive plate, and a second surface of the light transmissive plate at an opposite side of the light transmissive plate to the first surface, the first surface is a rough surface, and the light blocking layer is formed on at least one of the first and second surfaces.

3. The light blocking plate array of claim 1, wherein the light transmissive areas are arranged in an array.

4. The light blocking plate array of claim 1, further comprising at least two alignment through holes in the peripheral area of the light transmissive plate.

5. The light blocking plate array of claim 1, further comprising a plurality of filter layers, wherein the light blocking layer defines a plurality of through holes at the light transmissive areas, respectively, and the filter layers are formed in the through holes, respectively.

6. A lens module array comprising:
a lens array, the lens array comprising a plurality of lenses spaced apart from each other;
a light blocking plate array attached on the lens array, the light blocking plate array comprising a light transmissive plate, and a light blocking layer formed on the light transmissive plate, the light transmissive plate comprising a plurality of light transmissive areas spaced apart from each other, and a peripheral area surrounding the light transmissive areas, each of the light transmissive areas being a solid structure, the light blocking layer formed on the peripheral area.

7. The lens module array of claim 6, wherein the peripheral area comprises a first surface of the light transmissive plate, and a second surface of the light transmissive plate at an opposite side of the light transmissive plate to the first surface, the first surface is a rough surface, and the light blocking layer is formed on at least one of the first and second surfaces.

8. The lens module array of claim 6, wherein the light transmissive areas are arranged in an array.

9. The lens module array of claim 6, wherein the light blocking plate array further comprises at least two alignment through holes in the peripheral area of the light transmissive plate, the lens array further comprises at least two alignment structures among or surrounding the lenses, and the alignment through holes are aligned with the respective alignment structures, thereby ensuring that the light transmissive areas are coaxial with the respective lenses.

10. The lens module array of claim 9, wherein the alignment structures are selected from the group consisting of protrusions, recesses, and through holes.

11. The lens module array of claim 6, wherein the light blocking plate array further comprises a plurality of filter layers, the light blocking layer defines a plurality of through holes at the respective light transmissive areas, respectively, and the filter layers are formed in the through holes, respectively.
